(19) United States
(12) Patent Application Publication
(10) Pub. No.: US 2017/0116629 A1
(43) Pub. Date: Apr. 27, 2017

(54) SYSTEM FOR SEARCHING EXISTING CUSTOMER EXPERIENCE INFORMATION THROUGH CROSS-INDUSTRIES FROM TEXT DESCRIPTIONS ON A CUSTOMER EXPERIENCE

(71) Applicant: INTERNATIONAL BUSINESS MACHINES CORPORATION, Armonk, NY (US)

(72) Inventors: Yeuneu Chang, Tokyo (JP); Hironori Takeuchi, Kanagawa-ken (JP); Masayoshi Teraguchi, Kanagawa-ken (JP)

(21) Appl. No.: 14/923,016

(22) Filed: Oct. 26, 2015

(51) Int. Cl. G06Q 30/02

(52) U.S. Cl. CPC G06Q 30/0204

(57) ABSTRACT

A method for searching customer experience information that includes classifying customer experience data from a database of customer journey maps into customer segment groups and business industry groups. Terms may then be extracted from the customer segments groups and the business industry groups to provide a customer segment group dictionary, and a business industry specific dictionary. The method may continue with extracting keywords from a search customer experience using a hardware processor, and selecting from the keywords search terms using the business industry specific dictionary and the customer segment group dictionary to remove redundant terms. The customer experience data may then be searched with the search terms.

### BACKGROUND

Technical Field

The present invention relates generally to information processing and, in particular, the development of frameworks for modelling relationships between personas and industries.

Description of the Related Art

A customer journey map tells the story of the customer's experience: from initial contact, through the process of engagement and into a long-term relationship. A customer journey map can identify key interactions that the customer has with the organization. The customer journey may can provide information on a customer's feelings, and motivations. A customer journey map can appears as some type of infographic.

### SUMMARY

According to an aspect of the present principles, a method is provided for searching existing customer experience information through cross-industries from text descriptions on a customer experience. In one embodiment, the method includes providing customer experience data from a database of customer journey maps, and classifying the customer experience data from the database of customer journey maps into customer segment groups. Extracting terms from customer segments groups to provide a customer segment group dictionary. The method may further include classifying the customer experience data from the database of customer journey maps into business industry groups and extracting terms from the business industry groups to provide a business industry specific dictionary. A search customer experience can be input into a customer experience searcher. The customer experience searcher extracts keywords from the search customer experience using a hardware processor and assigns weights to the keywords using the business industry specific dictionary and the customer segment group dictionary to provide key words. The method may further include searching the customer experience data from a database of customer journey maps with the key words.

According to another aspect of the present principles, a system is provided for searching existing customer experience information through cross-industries from text descriptions on a customer experience. In one embodiment, the system includes a customer experience database of customer journey maps. The system may further includes a customer experience database sorter module that classifies customer experience data from the database; a customer segment specific dictionary database for storing a customer segment specific dictionary from the customer experience data classified by the customer experience database sorter; and a business industry specific dictionary database for storing a business industry specific dictionary from the customer experience data classified by the customer experience database sorter. A customer experience search module for extracting keywords from a search customer experience and assigning weights to the keywords using the business industry specific dictionary and the customer segment group dictionary to provide key words, the customer experience search module searching the customer experience data from a database of customer journey maps with the key words.

In accordance with another aspect of the present disclosure a non-transitory article of manufacture is provided that tangibly embodies a computer readable program. In one embodiment, a non-transitory computer readable storage medium is provided that includes a computer readable program for searching existing customer experience information through cross-industries from text descriptions on a customer experience. The computer readable program when executed on a computer causes the computer to perform the steps of classifying the customer experience data from a database of customer journey maps into customer segment groups, and extracting terms from customer segments groups to provide a customer segment group dictionary. The steps executed may further include classifying the customer experience data from the database of customer journey maps into business industry groups and extracting terms from the business industry groups to provide a business industry specific dictionary. A search customer experience can be input into a customer experience searcher, wherein the customer experience searcher extracts keywords from the search customer experience and assigns weights to the keywords using the business industry specific dictionary and the customer segment group dictionary to provide key words. The steps executed by the computer may further include searching the customer experience data from a database of customer journey maps with the key words.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system to which the present principles may be applied, in accordance with an embodiment of the present principles.

FIG. 2 is a block diagram illustrating an exemplary system for searching existing customer experience information through cross-industries from text descriptions on a customer experience, in accordance with an embodiment of the present principles.

FIG. 3 is a schematic illustrating the inputs and outputs of one embodiment of a system for searching existing customer experience information through cross-industries from text descriptions on a customer experience.

FIG. 4 is a is a flow/block diagram illustrating one embodiment of method for searching existing customer experience information through cross-industries from text descriptions on a customer experience, in accordance with one embodiment of the present disclosure.

FIG. 5 is a schematic illustrating one embodiment of method for searching existing customer experience information through cross-industries from text descriptions on a customer experience.

FIG. 6 shows an exemplary cloud computing node, in accordance with an embodiment of the present principles;

FIG. 7 shows an exemplary cloud computing environment, in accordance with an embodiment of the present principles.

FIG. 8 shows exemplary abstraction model layers, in accordance with an embodiment of the present principles.

### DETAILED DESCRIPTION OF PREFERRED EMBODIMENTS

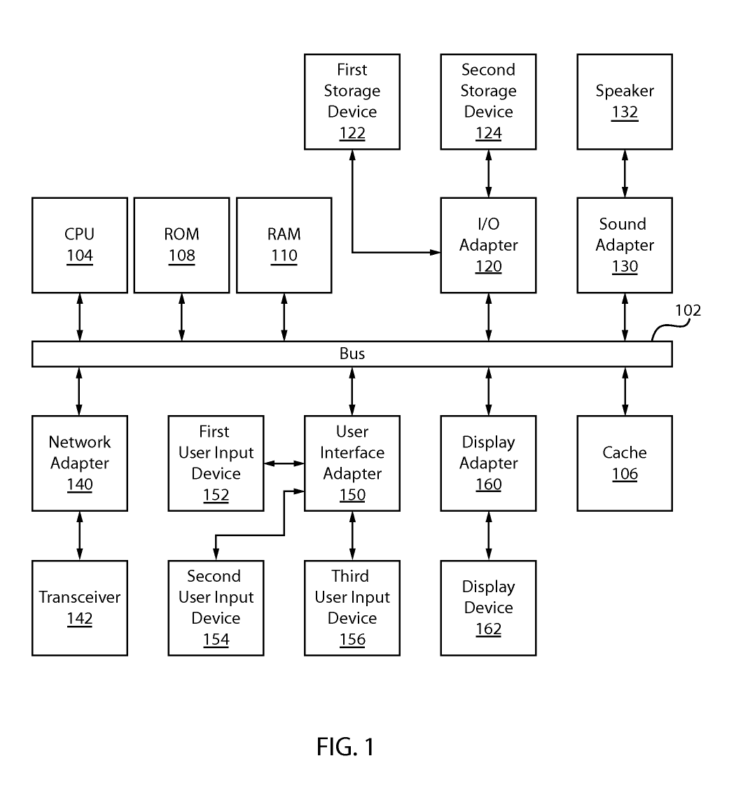

The present principles are related to customer journey maps (CJM). Customer journey maps is one service design method that can provide a way to work out a new business model. Advantageously, the customer journey map can include features that allow clients using the customer journey map to contemplate a business model, idea or product from the perspective of a customer, e.g., as an aspect of the customer experience (CX). The customer journey maps disclosed herein may be suitable for exploring the suitability of business models in fields such as banking, financial, insurance, automotive, etc. The customer journey map may take into account the persona of a client. One example, of a client persona would include age, gender and level of education. For example, a persona could be a female that is 23 years of age and has a high school graduate level of education. The customer journey map may also provide information describing a sequence of customer experiences (CX) at each moment of a new business model. For example, the customer journey map can provide descriptions of customer behaviour and emotions. One problem with customer journey maps is that they are not dictated by any specific a standards, structures or formats. Due to the absence of specific standards, structures and formats for making customer journey maps, customer journey maps are typically created based upon circumstances, such as target customer segments or business industries. Therefore, it can be difficult to search similar customer experience's (CX) from other customer journey maps by using typical search terms. In some embodiments, the methods, systems and computer program products provided herein allow for searching of existing customer experience information through cross-industries from text descriptions of customer experience. For example, descriptions for customer experience (CX) including information on customer segments, e.g., persona and business industries, are extracted from accumulated customer service maps and stored in a database, e.g., customer segment database (DB). In some embodiments, the methods, systems and computer program products that are disclosed herein improve search performance (e.g., accuracy of retrieved results) to find out similar customer experiences (CX) from other customer journey maps in the database when a query, such as a new description of customer experience (CX) focusing on set-up industries and customer segments, is input during the customer journey map session. The methods, systems and structures of the present disclosure are now described in greater detail with reference to FIGS. 1-8.

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

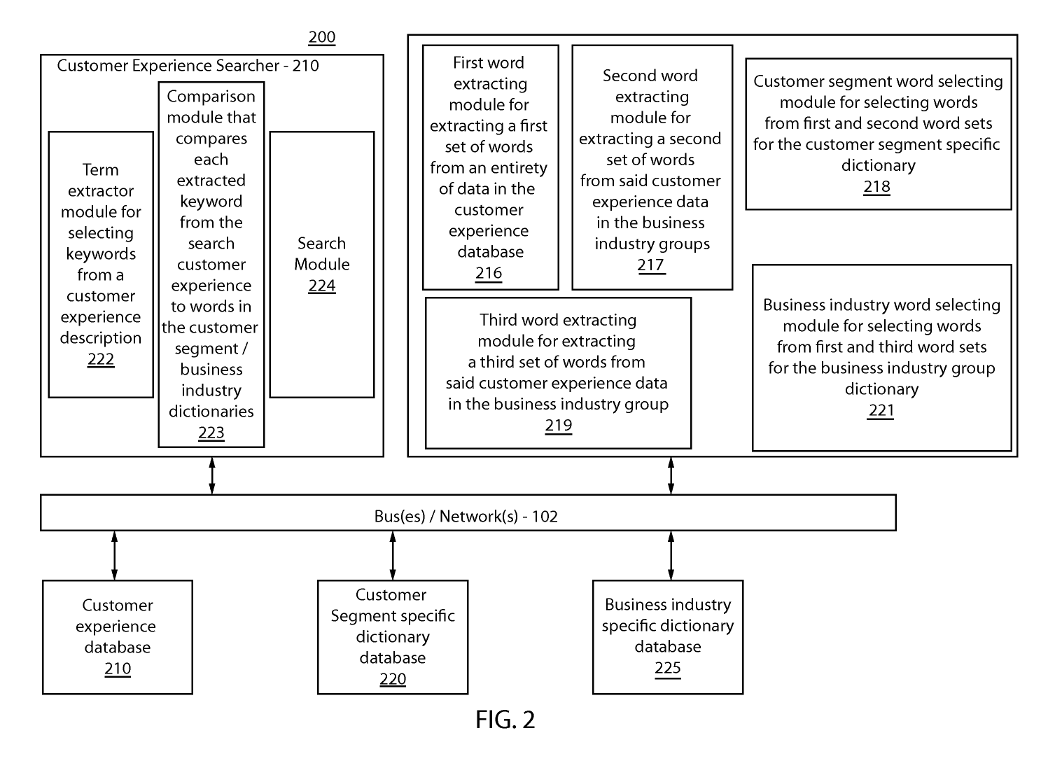

Moreover, it is to be appreciated that system 200 described below with respect to FIG. 2 is a system for implementing respective embodiments of the present principles. Part or all of processing system 100 may be implemented in one or more of the elements of system 200.

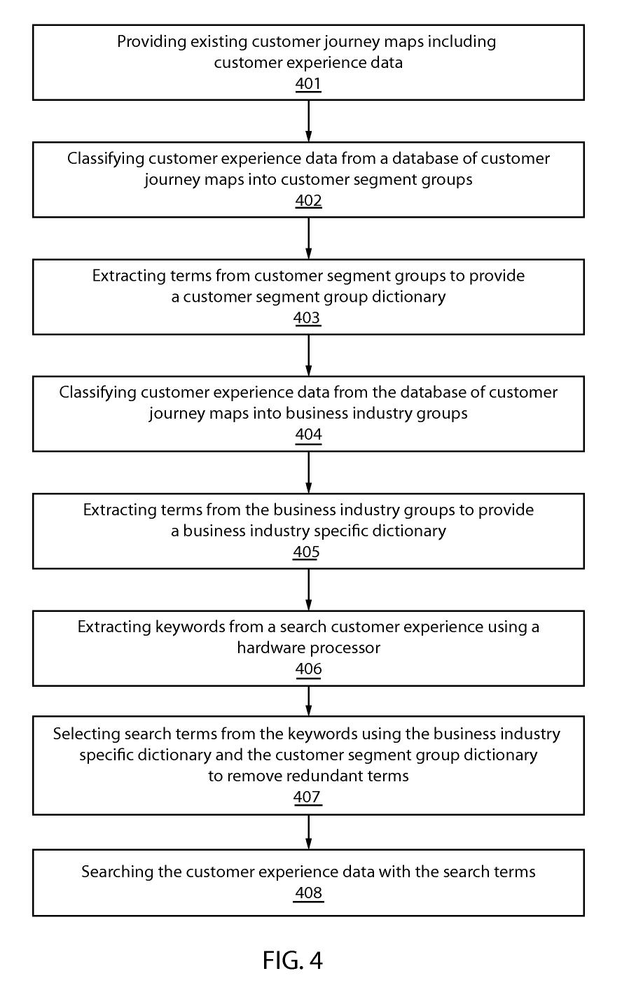

Further, it is to be appreciated that processing system 100 may perform at least part of the method described herein including, for example, at least part of method 300 of FIG. 4. Similarly, part or all of system 200 may be used to perform at least part of method 300 of FIG. 4.

FIG. 2 shows an exemplary system 200 for searching existing customer experience information through cross-industries from text description on a customer experience, in accordance with an embodiment of the present principles. The system 200 includes a customer experience searcher 210, a customer experience database (DB-1) 205, a customer experience database sorter 215 and a customer-segment specific dictionary database of customer experiences (DB-2) 220 and/or a business-segment specific dictionary database of customer experiences (DB-3) 225.

The customer experience database 205 can include descriptions of customer experience, business industry information, target customer segment information, as well as other optional information, such as feasible means and key performance indicators (KPI) etc. that are extracted from a set of existing customer journey maps (CJM) and are stored in a database as preliminary data. In one embodiment, each record in this database includes data groups. In one example, each record includes three data groups, such as 1) a description of a customer experience, 2) business industry information, and 3) target consumer segment information. Examples of a description of customer experience can include a description of emotions, and objective being reached. Examples of business industry can include retail sales, automotive service, legal service, insurance, medical care, investments services, and banking services. Examples of target customer segments can include tourists, college students, lawyers, doctors, children and combinations thereof. It is noted records including three data groups is only one example of a record for use with the present disclosure, and is not intended that the methods, systems and computer program products disclosed herein are limited to only this example, because embodiments have been contemplated in which more or less data groups are included for each record of the customer experience database 205. In an embodiment, the customer experience database 205 is implemented as a hard disk or optical disk memory device or a solid state drive (SSD). In an embodiment, the customer experience database 205 is implemented as, or includes, a cache.

The customer experience database sorter 215 classifies the customer experience (CX) data. The input to the customer experience database sorter 215 is the preliminary data provided by the existing customer journey maps. By classifying the customer experience (CX) data, the customer experience database sorter 215 can provide a customer-segment specific dictionary that can be stored in the customer-segment specific dictionary database of customer experiences (DB-2) 220. As noted above, customer segments are characterize by persona, e.g., age, gender, nationality, religion, level of education, profession and other means for characterizing a type of person, i.e., customer. By classifying the customer experience (CX) data, the customer experience database sorter 215 can provide a business-industries specific dictionary that can be stored in the business-industries specific dictionary database of customer experiences (DB-3) 225. As noted above, business industries can be characterized by retail sales, automotive service, legal service, insurance, medical care, investments services, tourism, and banking services.

In one embodiment, the customer experience database sorter 215 classifies the customer experience (CX) data using morphological analysis technology. Morphological analysis involves dividing texts written in natural language into morphemes that are the units of linguistic significance and thereby providing morpheme-by-morpheme information (e.g., parts of speech).

In one embodiment, the customer experience database sorter 215 extracts and sorts words from the customer experience (CX) data to create a customer-segment specific dictionary 220.

The morphological analysis conducted by the customer experience database sorter 215 for creating the customer-segment specific dictionary 220 may include a first step in which the database sorter extracts words from all the customer experience (CX) data in the customer experience database (DB-1) 205. This function can be provided by a first word extracting module 216. The words extracted from the customer experience (CX) data may be words extracted from the natural text of the descriptions of customer experience. Examples of a description of customer experience can include a description of emotions, and/or a description of an objective being reached with respect to a particular transaction or exchange, i.e., experience, such as experience with another party to a transaction. From the extracted words of the customer experience data, the customer experience database sorter 215, makes a list of the extracted words and their frequency (f1). The frequency of terms at this stage may be referred to as the word frequency from total customer (CX) data (f1).

The morphological analysis conducted by the customer experience database sorter 215 for creating the customer-segment specific dictionary 220 may include a second step in which the database sorter extracts words from each data group of customer segments within the customer experience (CX) data in the customer experience database (DB-1) 205. Data groups within the customer experience (CX) data can include the different customer segments, i.e., personas, e.g., age, gender, nationality, religion, level of education, profession and other means for characterizing a type of person, i.e., customer. In some embodiments, the customer experience database sorter 215 uses morphological analysis to extract words from each customer experience (CX) data group that is characterized by customer segments and makes a list of the words and their frequency (f2). This function can be provided with the second word extracting module 217. The frequency of terms at this stage may be referred to as the word frequency from groups of customer segments (f2).

In a third step, the customer experience database sorter 215 sets words having a word frequency from groups of customer segments (f2) that are higher than the words having a word frequency from total customer (CX) data (f1) as words that are components of the customer-segment specific dictionary for a customer segment that can be stored in the customer-segment specific dictionary database of customer experiences (DB-2) 220. The third step may be conducted by a customer segment word selecting module 218.

In one embodiment, the customer experience database sorter 215 extracts and sorts words from the customer experience (CX) data to create a business-segment industry dictionary 225.

The morphological analysis conducted by the customer experience database sorter 215 for creating the business-segment industry dictionary 225 may include a first step in which the database sorter extracts words from all the customer experience (CX) data in the customer experience database (DB-1) 205. This function may be performed by a first word extracting module 216. The words extracted from the customer experience (CX) data may be words extracted from the natural text of the descriptions of customer experience. From the extracted words of the customer experience data, the customer experience database sorter 215, makes a list of the extracted words and their frequency (f1), which may be referred to as the word frequency from total customer (CX) data (f1).

The morphological analysis conducted by the customer experience database sorter 215 for creating the business-segment industry dictionary 225 may include a second step in which the database sorter extracts words from each data group for business-industries within the customer experience (CX) data in the customer experience database (DB-1) 205. This function may be performed by a third word extracting module 219. Data groups within the customer experience (CX) data for the different business-industries can include retail sales, automotive service, legal service, insurance, medical care, investments services, travel and tourism services and banking services. In some embodiments, the customer experience database sorter 215 uses morphological analysis to extract words from each customer experience (CX) data group that is characterized by business industries and makes a list of the words and their frequency (f3). The frequency of terms at this stage may be referred to as the word frequency from groups of business industries (f3).

In a third step, which may be performed by a business word selecting module 221, the customer experience database sorter 215 for creating the business-segment industry dictionary sets words having a word frequency from groups of business industries (f3) that are higher than the words having a word frequency from total customer (CX) data (f1) as words that are components of the business-industry specific dictionary for a customer segment that can be stored in the business-industry specific dictionary database of customer experiences (DB-3) 225. In an embodiment, the customer experience database sorter 215, as well as at least one of the first, second, and third word extracting modules, 216, 217, 218, as well as the customer segment word selecting module 219 and the business industry word selecting module 221, is implemented as a hard disk or optical disk memory device or a solid state drive (SSD). In an embodiment, the customer experience database 205 is implemented as, or includes, a cache.

Each of the business-industry specific dictionary database of customer experiences (DB-3) 225 and customer-segment specific dictionary database of customer experiences (DB-2) 220 store the results from the customer experience database sorter 215 and may be implemented as a hard disk or optical disk memory device or a solid state drive (SSD).

Still referring to FIG. 2, the system 200 includes a customer experience searcher 210. The input into the customer experience searcher 210 is new data (e) (obtain list of words W=(w1, w2, . . . )). For example, new descriptions of customer experience (CX), which can be in natural language, as well as information on customer segment and business industry. In some embodiments, by using morphological analysis technology, the customer experience searcher 210 extracts words from the new data (e) to obtain a list of words (w). This function may be performed by a term extractor module 222. The customer experience searcher 210 may then load dictionaries from the business-industry specific dictionary database of customer experiences (DB-3) 225 and the customer-segment specific dictionary database of customer experiences (DB-2) 220. Through looking up words in the customer-segment specific dictionary, the customer experience searcher 210 excludes words (or reduces the weight of words) that are registered in the dictionary for the customer segment from the list of words extracted from the new data. This step may be performed by the comparison module 223. This list of words extracted from the new data minus the words that are registered in the dictionary for the customer segment may be referred to as the customer segment dictionary list of key words (W) taken from the new data (e).

In a following step, the customer experience searcher 210 may then look up words in the customer segment dictionary list of key words (W) taken from the new data (e) with the business-industry specific dictionary to exclude words that are registered in the business industry specific dictionary. The words that are also included in the business-industry specific dictionary are either removed from the list or reduced in their weight as search terms. This list of words extracted from the new data minus the words (or having reduced weight terms) that are registered in the business industry specific dictionary may be referred to as the key words (W) taken from the new data (e) that are suitable for search terms (K=(k1, k2, . . . , kn)). This step may be performed by the comparison module 223.

The customer experience searcher 210 may then employ the key words (W) taken from the new data (e) that are suitable for search terms (K=(k1, k2, . . . , kn)) to search the customer experience database (DB-1) 205. The key words (W) taken from the new data (e) that are suitable for search terms (K=(k1, k2, . . . , kn)) improve search performance of existing customer journey maps (CJM) in the customer experience database (DB-1) 205 to provide search results of similar customer experiences (CX) from similar customer journey maps (CJM). This step may be performed by the search module 224.

In an embodiment, the customer experience searcher 210, as well as at least one of the term extractor module 222, comparison module 223, and the search module 224, is implemented as a hard disk or optical disk memory device or a solid state drive (SSD). In an embodiment, the customer experience searcher 210 is implemented as, or includes, a cache.

In the embodiment shown in FIG. 2, the elements thereof are interconnected by bus(es)/network(s) 102. However, in other embodiments, other types of connections can also be used. Moreover, in an embodiment, at least one of the elements of system 200 is processor-based, e.g., hardware processor-based. Further, while one or more elements may be shown as separate elements, in other embodiments, these elements can be combined as one element. For example, the business-industry specific dictionary database of customer experiences (DB-3) 225 and the customer-segment specific dictionary database of customer experiences (DB-2) 220 may be combined in a single storage element. The converse is also applicable, where while one or more elements may be part of another element, in other embodiments, the one or more elements may be implemented as standalone elements. These and other variations of the elements of system 200 are readily determined by one of ordinary skill in the art, given the teachings of the present principles provided herein, while maintaining the spirit of the present principles.

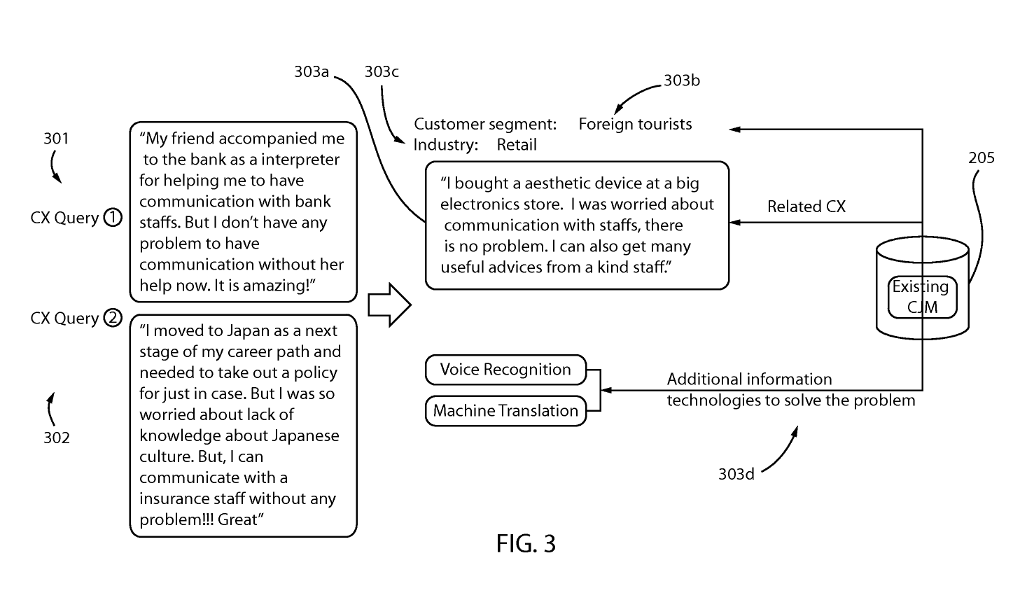

FIG. 3 shows an exemplary method 300 for incremental search based multi-modal journey planning. FIG. 3 depicts two inputs 301, 302, i.e., new customer experience descriptions (CX), in natural language form being entered into the customer experience searcher. These descriptions may be descriptions of customer experiences of a new business model/idea. The input to the searcher may also include customer segment information, e.g., persona, as well as business industry information. The customer experience searcher 210 selects key words for searching the customer experience database 205 using the customer specific dictionary database 220, and the business industry specific databases 225. The customer specific dictionary database 220, and the business industry specific databases 225 including dictionaries are provided by the customer experience database sorter 215. The output 303a may be a customer experience (CX) from the database of existing customer journey maps that are stored in the customer experience database 205. The output may also include a customer segment output 303b, e.g., foreign tourists, and business industry output 303c, e.g., retail. The output may also include an additional information 303d, such as technologies to solve a problem, e.g., voice recognition or machine translation.

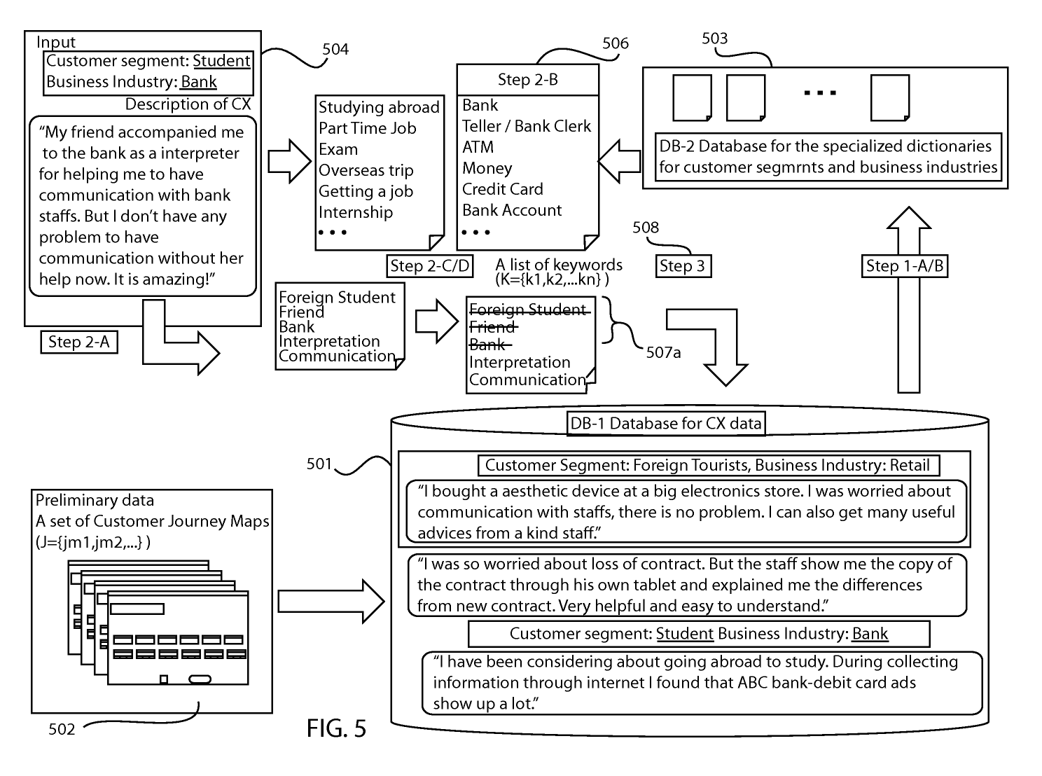

One embodiment of a method in accordance with the present disclosure is now described with reference to FIGS. 4 and 5. FIG. 4 is a flow chart illustrating one embodiment of method for searching existing customer experience information through cross-industries from text descriptions on a customer experience. FIG. 5 is a schematic illustrating searching existing customer experience information through cross-industries from text descriptions on a customer experience. In some embodiments, the method may begin with providing existing customer journey maps including customer experience data at 401. This can provide the database for customer experiences 501 (labelled DB-1) that is depicted in FIG. 5, in which the preliminary data is this embodiment is provided by customer journey maps 502. Further description of the database for customer experiences 501 is provide above by the description of the customer experience database 205 depicted in FIG. 2. For example, the customer experience data comprises descriptions of customer experience, business industry information, target customer segment information and combinations thereof.

At step 402, the method for searching customer experience information may classify the customer experience data (CX) from the database for customer experiences 501, which is provided by the customer journey maps 502, into customer segment groups. As noted above examples of customer segment groups may be persona's, e.g., age, gender, nationality, level of education, profession, etc. Further details on this stage of the method may be found above in the description of the first word extracting module 216 for extracting a first set of words from an entirety of data in the customer experience database of the customer experience database sorter 215 that is described above with reference to FIG. 2.

At step 403, the method may continue with extracting terms from customer segments groups to provide a customer segment group dictionary. In one embodiment, providing the customer segment group dictionary may include extracting a first set of words from substantially an entirety of the customer experience data in the database 501 of customer journey maps 502, wherein a first frequency of use may be assigned to each word in the first set of words. This step of the method may be provided by the first extracting module 216 of the customer experience database sorter 215 that is depicted in FIG. 2.

In a following step, a second set of words is extracted from said customer experience data in the customer segment groups, wherein a second frequency of use is assigned to each word in the second set of words. In one embodiment, this step of the method may be provided by the second extracting module 217 of the customer experience database sorter 215 that is depicted in FIG. 2. For example, extracting the first set of words may include morphological analysis.

The method sequence for forming the customer segment group dictionary may continue with selecting words having a second frequency that is greater than the first frequency for the customer segment group dictionary. In one embodiment, this step of the method may be provided by the customer segment word selecting module 218 of the customer experience database sorter 215 that is depicted in FIG. 2. For example, extracting the second set of words may include morphological analysis.

Referring to FIG. 4, the method may continue with classifying the customer experience data from the database of customer journey maps into business industry groups, at step 404. The business industry groups may include business type information for customer experiences comprising retail sales, automotive service, legal service, insurance, medical care, investments services, banking services and combinations thereof. Further details on this stage of the method may be found above in the description of the first word extracting module 216 for extracting a first set of words from an entirety of data in the customer experience database of the customer experience database sorter 215 that is described above with reference to FIG. 2. For example, extracting the first set of words may include morphological analysis.

Step 405 of the method may include extracting terms from the business industry groups to provide a business industry specific dictionary. In some embodiments, creating the business industry specific dictionary can include extracting a first set of words from substantially an entirety of the customer experience data (CX) in the database 501 of customer journey maps 502, wherein a first frequency of use is assigned to each word in the first set of words. This step has been described above with reference to FIG. 2, and may include the first word extracting module 216 of the customer experience database sorter 215. Thereafter, a third set of words can be extracted from the customer experience data in the business industry groups, wherein a third frequency of use is assigned to each word in the third set of words. This step of the method may include the third word extracting module 210 of the customer experience database sorter 215 that is depicted in FIG. 2. For example, extracting the third set of words may include morphological analysis.

In some embodiments, the method may continue with selecting words having a third frequency that is greater than the first frequency for the business industry group dictionary. This step may be provide by the business industry word selecting module 221 of the customer experience database sorter 215 that is depicted in FIG. 2.

The above described steps 402-405 may provide the database 503 for specific dictionaries for customer segments for business industries that is depicted in FIG. 5. Further details for these databases are provided above in the description of the customer segment specific dictionary database 220 and the business industry specific dictionary database 220 that are described above with reference to FIG. 2.

Referring to FIG. 4, the method may include extracting keywords from a new search customer experience using a hardware processor at step 406. At this stage, the new customer experience 504 data is the input depicted in FIG. 5. In some embodiments, extracting keywords from the search customer experience comprises selecting keywords from natural text of a consumer experience, i.e., a word description of an experience. The input can also include information on the customer segment, e.g., persona, such as student, and the business industry, e.g., banking. The extraction of keywords may be provided by the term extractor module 222 of the customer experience searcher 210 that is described above with reference to FIG. 2. For example, extracting keywords from said search customer experience comprises morphological analysis. The keywords selected are illustrated in FIG. 5 by reference number 505.

At step 407 of the method depicted in FIG. 4, search terms are selected from said keywords using the business industry specific dictionary and the customer segment group dictionary to remove redundant terms. This step of the method may be performed using the comparison module 223 of the customer experience searcher 210 that is described above with reference to FIG. 2. Referring to FIGS. 2, 5 and 5, in some embodiments, the method may include comparing each extracted keyword from the search customer experience to words in the customer segment group dictionary. This is depicted in FIG. 5 by reference number 506. Each extracted keyword from the search customer experience that is equal to at least one of said words in the customer segment group dictionary is weighted to provide a weighted set of extracted keywords, as depicted by reference number 507. Words that are weighted according to at least one of the customer segment group dictionary can be eliminated from being search terms, or the words that are weighted according to at least one of the customer segment group dictionary can be reduced in search value in the search terms when compared to a remainder of words in the search terms. In some embodiments, after weighing the search terms in view of the customer segment group dictionary, the method can continue with comparing each extracted keyword in the weighted set of extracted keywords to words in the business industry group dictionary. Each extracted keyword that is equal to at least one of said words in the business industry group dictionary is weighted to provide the search terms. This is depicted by reference number 507a, as depicted in FIG. 5. Words that are weighted according to at least one of the business industry specific dictionary can be eliminated from being search terms, or the words that are weighted according to at least one of the business industry specific dictionary can be reduced in search value in the search terms when compared to a remainder of words in the search terms. In this embodiment, redundant terms are eliminated from the list of search terms.

Referring to step 408 of FIG. 4, a search of the customer experience data with the search terms may then be conducted. This is illustrated by reference number 508 in FIG. 5. The output of the search may include customer experience descriptions, as well as business industry and customer segment information relating to the customer experience descriptions matching the search terms.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

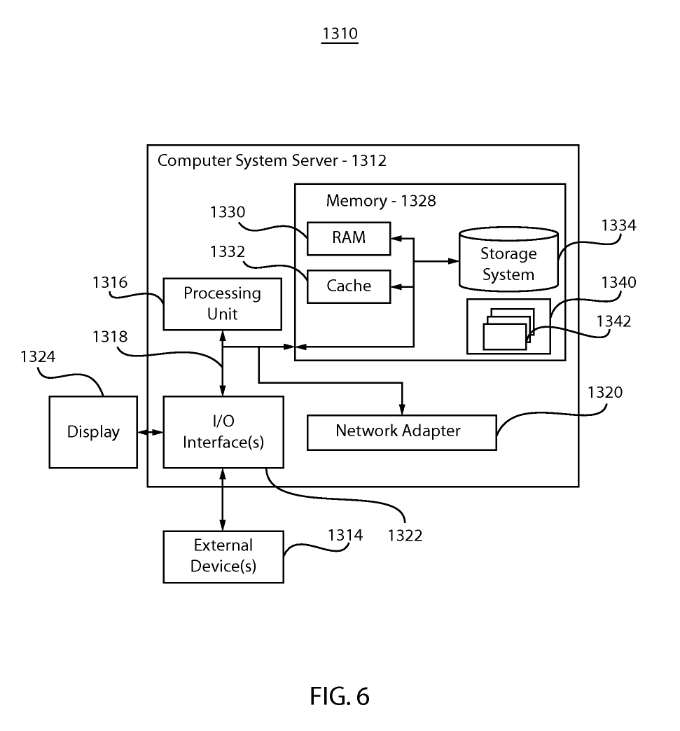

Referring now to FIG. 6, a schematic of an example of a cloud computing node 1310 is shown. Cloud computing node 1310 is only one example of a suitable cloud computing node and is not intended to suggest any limitation as to the scope of use or functionality of embodiments of the invention described herein. Regardless, cloud computing node 1310 is capable of being implemented and/or performing any of the functionality set forth hereinabove.

In cloud computing node 1310 there is a computer system/server 1312, which is operational with numerous other general purpose or special purpose computing system environments or configurations. Examples of well-known computing systems, environments, and/or configurations that may be suitable for use with computer system/server 1312 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1312 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1312 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 1312 in cloud computing node 1310 is shown in the form of a general-purpose computing device. The components of computer system/server 1312 may include, but are not limited to, one or more processors or processing units 1316, a system memory 1328, and a bus 1318 that couples various system components including system memory 1328 to processor 1316.

Bus 1318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1312 typically includes a variety of computer system readable media. Such media may be any available media that is accessible by computer system/server 1312, and it includes both volatile and non-volatile media, removable and non-removable media.

System memory 1328 can include computer system readable media in the form of volatile memory, such as random access memory (RAM) 1330 and/or cache memory 1332. Computer system/server 1312 may further include other removable/non-removable, volatile/non-volatile computer system storage media. By way of example only, storage system 1334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1318 by one or more data media interfaces. As will be further depicted and described below, memory 1328 may include at least one program product having a set (e.g., at least one) of program modules that are configured to carry out the functions of embodiments of the invention.

Program/utility 1340, having a set (at least one) of program modules 1342, may be stored in memory 1328 by way of example, and not limitation, as well as an operating system, one or more application programs, other program modules, and program data. Each of the operating system, one or more application programs, other program modules, and program data or some combination thereof, may include an implementation of a networking environment. Program modules 1342 generally carry out the functions and/or methodologies of embodiments of the invention as described herein. For example, the program modules 1342 can include the modules described with reference to FIG. 2.

Computer system/server 1312 may also communicate with one or more external devices 1314 such as a keyboard, a pointing device, a display 1324, etc.; one or more devices that enable a user to interact with computer system/server 1312; and/or any devices (e.g., network card, modem, etc.) that enable computer system/server 1312 to communicate with one or more other computing devices. Such communication can occur via Input/Output (I/O) interfaces 1322. Still yet, computer system/server 1312 can communicate with one or more networks such as a local area network (LAN), a general wide area network (WAN), and/or a public network (e.g., the Internet) via network adapter 1320. As depicted, network adapter 1320 communicates with the other components of computer system/server 1312 via bus 1318. It should be understood that although not shown, other hardware and/or software components could be used in conjunction with computer system/server 1312. Examples, include, but are not limited to: microcode, device drivers, redundant processing units, external disk drive arrays, RAID systems, tape drives, and data archival storage systems, etc.

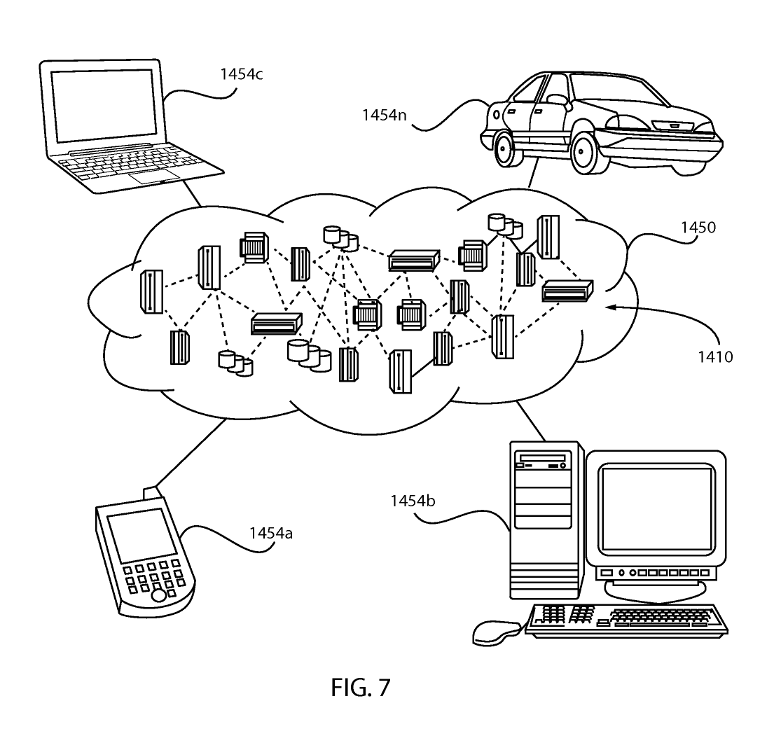

Referring now to FIG. 7, illustrative cloud computing environment 1450 is depicted. As shown, cloud computing environment 1450 comprises one or more cloud computing nodes 1410 with which local computing devices used by cloud consumers, such as, for example, personal digital assistant (PDA) or cellular telephone 1454A, desktop computer 1454B, laptop computer 1454C, and/or automobile computer system 1454N may communicate. Nodes 1410 may communicate with one another. They may be grouped (not shown) physically or virtually, in one or more networks, such as Private, Community, Public, or Hybrid clouds as described hereinabove, or a combination thereof. This allows cloud computing environment 1450 to offer infrastructure, platforms and/or software as services for which a cloud consumer does not need to maintain resources on a local computing device. It is understood that the types of computing devices 1454A-N shown in FIG. 7 are intended to be illustrative only and that computing nodes 1410 and cloud computing environment 1450 can communicate with any type of computerized device over any type of network and/or network addressable connection (e.g., using a web browser).

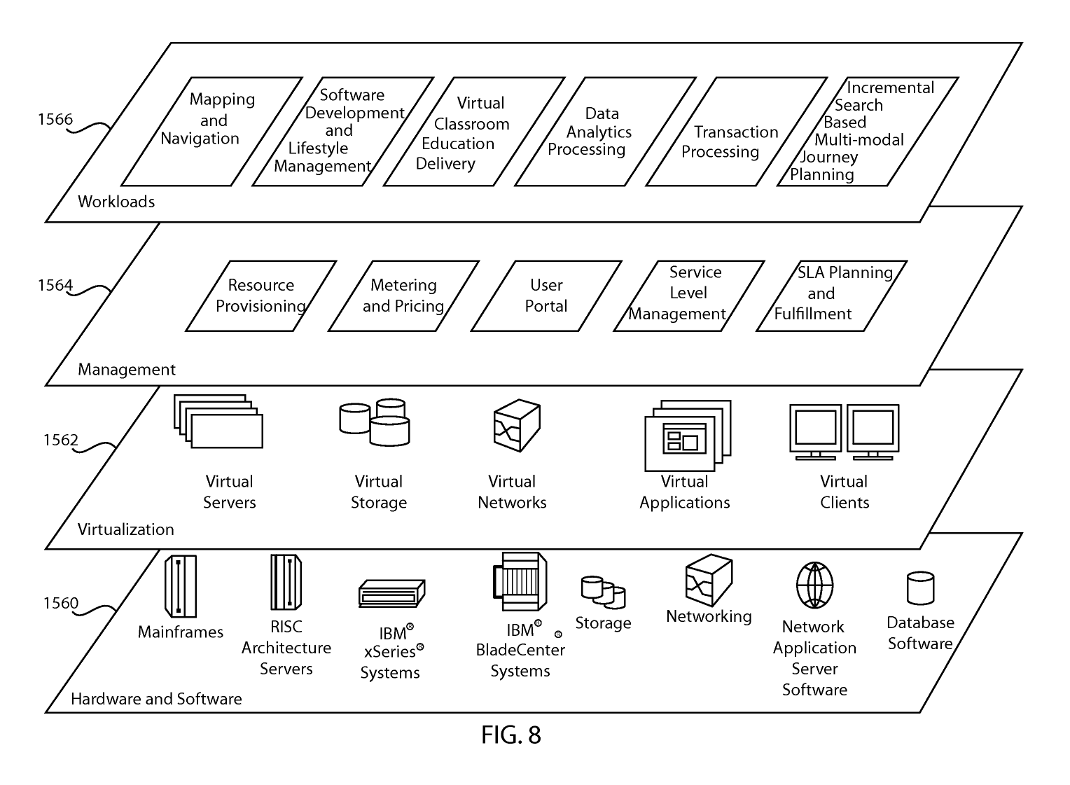

Referring now to FIG. 8, a set of functional abstraction layers provided by cloud computing environment 1550 (FIG. 6) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1560 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1562 provides an abstraction layer from which the following examples of virtual entities may be provided: virtual servers; virtual storage; virtual networks, including virtual private networks; virtual applications and operating systems; and virtual clients.

In one example, management layer 1564 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1566 provides examples of functionality for which the cloud computing environment may be utilized. Examples of workloads and functions which may be provided from this layer include: mapping and navigation; software development and lifecycle management; virtual classroom education delivery; data analytics processing; transaction processing; and incremental search based multi-modal journey planning.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for searching customer experience information comprising:
classifying customer experience data from a database of customer journey maps into customer segment groups;
extracting terms from the customer segments groups to provide a customer segment group dictionary;
classifying the customer experience data from the database of customer journey maps into business industry groups;
extracting terms from the business industry groups to provide a business industry specific dictionary;
extracting keywords from a search customer experience using a hardware processor;
selecting from said keywords search terms using the business industry specific dictionary and the customer segment group dictionary to remove redundant terms; and
searching the customer experience data with the search terms.

2. The method of claim 1, wherein the customer experience data comprises descriptions of customer experience, business industry information, target customer segment information or a combination thereof.

3. The method of claim 1, wherein customer segment groups include persona information for customer experiences comprising gender, age, level of education, religion, nationality, profession or a combination thereof.

4. The method of claim 1, wherein the business industry groups include business type information for customer experiences comprising retail sales, automotive service, legal service, insurance, medical care, investments services, banking services and combinations thereof.

5. The method of claim 1, wherein providing said customer segment group dictionary comprises:
extracting a first set of words from substantially an entirety of the customer experience data in the database of customer journey maps, wherein a first frequency of use is assigned to each word in the first set of words;
extracting a second set of words from said customer experience data in the customer segment groups, wherein a second frequency of use is assigned to each word in the second set of words; and
selecting words having a second frequency that is greater than the first frequency for said customer segment group dictionary.

6. The method of claim 5, wherein at least one of said extracting said first set of words, and said extracting said second set of words comprises morphological analysis.

7. The method of claim 1, wherein said providing the industry specific dictionary comprises:
extracting a first set of words from substantially an entirety of the customer experience data in the database of customer journey maps, wherein a first frequency of use is assigned to each word in the first set of words;
extracting a third set of words from said customer experience data in the business industry groups, wherein a third frequency of use is assigned to each word in the third set of words; and
selecting words having a third frequency that is greater than the first frequency for said business industry group dictionary.

8. The method of claim 7, wherein at least one of said extracting said first set of words, and said extracting said third set of words comprises morphological analysis.

9. The method of claim 1, wherein said extracting keywords from said search customer experience comprises selecting keywords from natural text of a consumer experience.

10. The method of claim 9, wherein extracting keywords from said search customer experience comprises morphological analysis.

11. The method of claim 1, wherein said selecting from said keywords search terms using the business industry specific dictionary and the customer segment group dictionary to remove redundant terms comprises:
comparing each extracted keyword from the search customer experience to words in the customer segment group dictionary, wherein said each extracted keyword that is equal to at least one of said words in the customer segment group is weighted to provide a weighted set of extracted keywords; and
comparing each extracted keyword in said weighted set of extracted keywords to words in the business industry group dictionary, wherein said each extracted keyword that is equal to at least one of said words in the business industry group dictionary is weighted to provide the search terms.

12. The method of claim 11, wherein said words that are weighted according to at least one of the customer segment group dictionary and the business industry group dictionary are eliminated from being search terms.

13. The method of claim 11, wherein said words that are weighted according to at least one of the customer segment group dictionary and the business industry group dictionary are reduced in search value in the search terms when compared to a remainder of words in the search terms.

14. A system for searching customer experience comprising:
a customer experience database of customer journey maps;
a customer experience database sorter module that classifies customer experience data from the customer experience database into a customer segment specific group and a business industry specific group;
a customer segment specific dictionary database for storing a customer segment specific dictionary from the customer segment specific group classified by the customer experience database sorter;
a business industry specific dictionary database for storing a business industry specific dictionary from the business industry specific group classified by the customer experience database sorter; and
a customer experience search module for extracting keywords from a search customer experience and assigning weights to the keywords using the business industry specific dictionary and the customer segment group dictionary to provide search terms, the customer experience search module searching the customer experience data from a database of customer journey maps with the search terms.

15. The system of claim 14, wherein the customer experience database sorter comprises:
a first word extracting module for extracting a first set of words from substantially an entirety of data in the customer experience database of customer journey maps, wherein a first frequency of use is assigned to each word in the first set of words;
a second word extracting module for extracting a second set of words from said customer experience data in the business industry groups, a second frequency of use is assigned to each word in the second set of words;
a customer segment word selecting module for selecting words for the customer segment specific dictionary having a second frequency that is greater than the first frequency for said customer segment group dictionary.

16. The system of claim 15, wherein at least one of said extracting said first set of words, and said extracting said second set of words comprises morphological analysis.

17. The system of claim 15, wherein said customer experience database sorter comprises:
a third word extracting module for extracting a third set of words from said customer experience data in the business industry group, wherein a third frequency of use is assigned to each word in the third set of words; and
a business industry word selecting module for selecting words having a third frequency that is greater than the first frequency for said business industry group dictionary.

18. The system of claim 15, wherein at least one of said extracting said third set of words comprises morphological analysis.

19. The system of claim 15, wherein said selecting from said keywords search terms using the business industry specific dictionary and the customer segment group dictionary to remove redundant terms comprises a comparison module that compares each extracted keyword from the search customer experience to words in the customer segment group dictionary, wherein said each extracted keyword that is equal to at least one of said words in the customer segment group is weighted to provide a weighted set of extracted keywords, wherein the comparison module compares each extracted keyword in said weighted set of extracted keywords to words in the business industry group dictionary, wherein said each extracted keyword that is equal to at least one of said words in the business industry group dictionary is weighted to provide the search terms.

20. A non-transitory computer readable storage medium comprising a computer readable program for lending battery charger devices, wherein the computer readable program when executed on a computer causes the computer to perform the steps of:
classifying the customer experience data from a database of customer journey maps into customer segment groups, and extracting terms from customer segments groups to provide a customer segment group dictionary;
classifying the customer experience data from the database of customer journey maps into business industry groups and extracting terms from the business industry groups to provide a business industry specific dictionary;
inputting a search customer experience into a customer experience searcher, wherein the customer experience searcher extracts keywords from the search customer experience and assigns weights to the keywords using the business industry specific dictionary and the customer segment group dictionary to provide key words; and
searching the customer experience data from a database of customer journey maps with the key words.
